(19) United States
(12) Patent Application Publication
(10) Pub. No.: US 2026/0267596 A1
(43) Pub. Date: Sep. 10, 2026

(54) SYSTEM AND METHOD FOR VOICE VOLUME SELF-REGULATION USING MULTI-STATE MONITORING WITH ADAPTIVE SAMPLING RATES

(71) Applicant: Sensory Bridges, LLC, Maryville, TN (US)

(72) Inventor: Megan Cales, Rock Spring, GA (US)

(73) Assignee: Sensory Bridges, LLC, Maryville, TN (US)

(21) Appl. No.: 19/557,509

(22) Filed: Mar. 5, 2026

Related U.S. Application Data
(60) Provisional application No. 63/767,320, filed on Mar. 5, 2025.

(51) Int. Cl. G06F 3/16; G08B 21/18; G10L 25/51; H04R 1/08; H04R 3/00

(52) U.S. Cl. CPC G06F 3/165; G08B 21/182; G10L 25/51; H04R 1/08; H04R 3/00; H04R 2420/07

(57) ABSTRACT

A wearable voice volume self-regulating device is disclosed. The device includes an audio sensor, a wearable housing, a haptic feedback element, and a controller for monitoring audio based solely on decibel levels without storing audio waveform data. The controller operates across multiple states: a first monitoring state that samples audio at a low sampling rate and compares measured volume to a first threshold; a second monitoring state with a higher sampling rate that compares volume to a higher second threshold; an alert state in which the haptic element provides tactile feedback to the user when the second threshold is exceeded; and a cooldown state that temporarily prevents reentry into the alert state to avoid vibration flicker. The device may be implemented in various wearable form factors including wristband, clip-on, and pendant configurations. Advantageously, the system provides real-time, private feedback for voice volume self-regulation.

### CROSS REFERENCE TO RELATED APPLICATION

This application claims the benefit of priority from U.S. Provisional Patent Application No. 63/767,320, filed Mar. 5, 2025, titled “Brooks Band,” which is incorporated herein by reference in its entirety.

### FIELD

This invention relates to wearable assistive technology devices, and more specifically to systems and methods for real-time voice volume self-regulation using multi-state monitoring with adaptive sampling rates and haptic feedback. The system enables individuals with neurodevelopmental differences, hearing impairments, or voice control challenges to independently monitor and regulate their speaking volume through immediate tactile feedback without recording or storing audio waveform data.

### BACKGROUND

Many individuals with neurodevelopmental differences or hearing impairments struggle with voice modulation. In other words, they may speak too loudly (or sometimes too quietly) without realizing it. This challenge affects multiple populations and has significant social, educational, and occupational implications.

Children on the autism spectrum or with attention-deficit/hyperactivity disorder (ADHD) often have difficulty gauging how loudly they are speaking due to differences in sensory processing and self-monitoring. Research indicates that autistic children can have trouble integrating auditory feedback, making it hard for them to know when they are speaking at an inappropriate volume for a given setting (e.g., too loud for a quiet classroom). This challenge is neurological in nature. It is not willful misbehavior, but rather a lack of real-time self-awareness of volume.

ADHD-related traits, such as impulsivity and reduced inhibitory control, further exacerbate the issue, leading to loud outbursts or difficulty maintaining an appropriate voice level. These behaviors can disrupt classrooms, strain social interactions, and cause frustration for both the individuals and those around them. Immediate feedback is known to be critical for learning self-regulation skills, yet caregivers and teachers cannot always intervene instantly or consistently in every situation.

People who are deaf or hard-of-hearing face a related but distinct problem in voice volume regulation. Because of an inability to hear themselves speak, deaf individuals may find it challenging to control how loudly or softly their voice is. They might unintentionally speak very loudly or, conversely, too softly, simply due to lack of auditory feedback. This can lead to misunderstandings or unwanted attention in public settings.

Existing assistive technologies for the hearing-impaired, such as hearing aids or cochlear implants, focus primarily on improving auditory input but may not provide a direct way for a person to monitor their own voice volume in real time. Thus, a gap exists for a device that can give immediate, accessible feedback to help regulate one's speaking volume through alternative sensory cues.

Prior solutions have attempted to address voice modulation problems with varying degrees of success. Noise-canceling headphones help many children with sensory sensitivities cope with loud environments by reducing overwhelming ambient noise. However, such headphones do nothing to help the child monitor or modulate their own voice volume. In fact, by muffling sound, headphones might make the child hear themselves even less, potentially causing them to speak even louder. Additionally, wearing headphones for long periods can socially isolate the child and does not build the child's self-awareness of speaking volume.

Behavior tracking apps and devices allow parents or teachers to log behaviors and reward good behavior. However, these systems operate retrospectively or in domains other than voice volume, and they do not provide real-time feedback for loud speech as it happens. A child might get a report or note about using an “inside voice” well after the moment has passed, which is not effective for immediate self-correction. The delay between the loud speaking behavior and the feedback makes it hard for the child to connect cause and effect.

Modern wearable devices such as smartwatches have various sensors and can run apps. However, these devices are not specifically designed for voice monitoring. They typically do not include algorithms tuned to detect loud speech or distinguish the wearer's voice from background noise. While a smartwatch has a microphone for phone calls or voice assistants, there is no out-of-the-box feature that gives haptic feedback for speaking too loudly. While a general-purpose smartwatch could theoretically be programmed to perform voice monitoring, no existing smartwatch application implements a multi-state monitoring architecture with adaptive sampling rates specifically designed for voice volume self-regulation. Existing smartwatch noise monitoring features, such as ambient sound level alerts, monitor environmental noise exposure for hearing protection purposes and do not distinguish the user's own voice from background noise, do not implement multi-state power management with dynamically varying sampling rates, and do not provide immediate haptic feedback specifically calibrated to help the user self-regulate their speaking volume.

Visual timers or visual schedules are commonly used to help neurodiverse children with transitions, routines, and understanding time visually. While effective for routine and task management, these do not address voice loudness at all.

Some specialized mobile apps turn a device's microphone into a voice volume meter, often with visual feedback such as changing colors or a gauge on the screen to represent loudness. The limitation of a purely app-based solution is that it typically requires the user to be actively watching a screen or staying near a device, which is impractical during natural conversation or activities.

Several patents and patent applications address related problems but fail to provide the specific combination of features necessary for effective voice volume self-regulation. U.S. Patent Application Publication No. 2015/0110277 A1 (“Pigeon”) describes a wearable device with a sound level meter, user-settable decibel threshold, vibrating unit, and visual LED alerts. However, the device described in this application does not implement the power-efficient multi-state monitoring approach with adaptive sampling rates of the present invention. The Pidgeon reference monitors general ambient sound rather than specifically isolating the user's own voice, and it lacks the sophisticated state machine architecture that enables efficient continuous operation. Furthermore, the Pidgeon reference explicitly describes recording and storing audio conversations for later playback, which is fundamentally contrary to the privacy-preserving architecture of the present invention wherein raw audio waveform data is never stored or transmitted.

U.S. Pat. No. 10,873,816 B2 (“Sonova”) describes providing feedback of own-voice loudness to users of hearing devices. This patent extracts own-voice signals via a hearing device microphone, determines sound level, and compares to context-adaptive thresholds. However, this system is limited to hearing devices and uses auditory or visual feedback rather than haptic feedback, requiring the user to rely on auditory or visual perception. The Sonova system is designed for individuals already using hearing aids and does not address the needs of neurodiverse individuals or provide a standalone wearable solution. Additionally, it does not employ a multi-state monitoring architecture with different sampling rates for power management.

U.S. Pat. No. 11,779,275 B2 describes a multi-sensory assistive wearable technology for sensory relief. This '275 patent describes a wearable connecting to user-specific sensory thresholds (auditory, visual, physiological), comparing input to thresholds, and providing intervention via haptic drivers. However, this system monitors incoming environmental stimuli (sensory overload from external sources) rather than the user's own voice output. Additionally, the '275 patent requires the intervention to comprise filtering, in real-time, an audio signal or optical signal presented to the user, namely actively modifying the sensory input the user receives. This is fundamentally different from the present invention, which does not filter or modify any signal presented to the user but instead alerts the user about their own voice output through haptic feedback, enabling conscious self-regulation rather than automated sensory mediation. It is designed to detect when external sensory input exceeds a threshold and provide relief, which is fundamentally different from monitoring and regulating the user's own speech production. The system does not address voice volume self-regulation or employ the multi-state adaptive sampling approach of the present invention.

U.S. Pat. No. 9,532,897 B2 describes devices that train voice patterns using a wearable earpiece with an accelerometer detecting speech. When speech is detected, the device plays multi-talker babble noise to elicit the Lombard effect, causing the user to involuntarily increase voice loudness. This system uses auditory feedback (noise stimulus) rather than haptic feedback, is limited to Parkinson's disease hypophonia applications, and is designed to increase rather than regulate volume. It does not provide the user with conscious self-regulation tools or address the needs of neurodiverse individuals or the deaf/hard-of-hearing population.

A wearable voice volume self-regulating system implementing a multi-state monitoring architecture with adaptive sampling rates wherein the system may be implemented on a dedicated wearable device or as a software application on a general-purpose wearable computing device operating in a restricted mode. Conventional systems that attempt to monitor ambient noise levels, such as occupational noise dosimeters, measure cumulative noise exposure for compliance purposes rather than providing real-time voice coaching. These systems do not distinguish between the user's own voice and environmental noise, do not provide haptic feedback, without storing audio waveform data, and are designed for industrial safety applications rather than personal voice modulation.

What is needed, therefore, is a system that provides real-time, immediate, and non-intrusive feedback specifically for voice volume regulation. The system must be able to distinguish the user's own voice from other noises (e.g., background noise and others' voices), operate continuously without constant user attention, deliver feedback through an accessible sensory channel that does not rely on auditory perception, and be efficient enough to operate on battery power for extended periods while maintaining responsiveness. Additionally, the system must protect user privacy by not recording or storing audio waveform data. No existing system provides this combination of capabilities.

### SUMMARY OF THE INVENTION

The present invention provides a voice volume self-regulating system that addresses the shortcomings of prior solutions by implementing a state-based monitoring approach with automatic transitions between operational modes. The system comprises an audio sensor configured to capture audio data, a wearable housing configured to be worn on a user's body, at least one haptic feedback element disposed in or on the wearable housing, and a controller operatively connected to the audio sensor and the haptic feedback element.

In some embodiments, the controller comprises a processor of a general-purpose wearable computing device, such as a smartwatch, executing software application instructions that implement the multi-state monitoring process. In such embodiments, the audio sensor comprises a microphone integrated into the wearable computing device, and the haptic feedback element comprises a vibration actuator integrated into the wearable computing device. The wearable computing device may operate in a restricted mode, such as a kiosk mode, that limits device functionality substantially to the voice volume self-regulating system.

The controller operates in multiple monitoring states that enable efficient power management while maintaining responsiveness. In a first monitoring state (referred to as a “Sentry” state), the controller samples audio data from the audio sensor at a first sampling rate (e.g., 1 Hz) and compares a volume level of the audio data against a first decibel threshold value (TH1). This first monitoring state functions as a low-power sentinel mode that continuously watches for potentially elevated voice volume without consuming excessive battery power or processing resources.

When the volume level meets or exceeds the first decibel threshold value, the controller automatically transitions to a second monitoring state (referred to as an “Elevated Monitor” state). In this second monitoring state, the controller samples the audio data at a second sampling rate (e.g., 60 Hz) greater than the first sampling rate and compares the volume level against a second decibel threshold value (TH2) greater than the first decibel threshold value. This elevated monitoring state provides higher resolution detection to accurately determine whether the user's voice has reached a level requiring feedback.

When the volume level meets or exceeds the second decibel threshold value while in the second monitoring state, the controller automatically transitions to an alert state (referred to as a “Vibrating” state) and activates the haptic feedback element to provide tactile feedback to the user. This immediate, private feedback alerts the user to their elevated voice volume, enabling them to self-correct without external intervention or embarrassment. The haptic feedback continues as long as the volume level remains at or above the second decibel threshold value.

When the volume level drops below the second decibel threshold value during the alert state, the controller automatically transitions to a cooldown state. This cooldown state prevents re-entry into the alert state for a predetermined cooldown duration (e.g., 3 seconds). This cooldown prevents rapid re-triggering and vibration flicker that could be annoying or confusing to the user. During the cooldown state, the controller continues to monitor voice volume at the second sampling rate but does not activate the haptic feedback element even if the volume level temporarily exceeds the second threshold. After the cooldown duration expires, the controller returns to the first monitoring state.

If, while in the second monitoring state, the volume level does not reach the second decibel threshold value within a predetermined monitoring duration, the controller automatically returns to the first monitoring state. This prevents the system from remaining in the higher-power elevated monitoring state indefinitely when the user's voice was only briefly elevated but did not reach the threshold requiring feedback.

Throughout all states, the system continuously monitors voice volume without storing audio waveform data, protecting user privacy while providing effective voice regulation assistance. The controller processes audio data to extract volume level information (e.g., decibel measurements) but immediately discards the raw audio waveform data. Only metadata such as timestamps of threshold exceedances, duration of alert states, and decibel measurements may be stored for later review via a companion application.

The state-based approach provides several advantages over continuous high-rate monitoring. By operating at a lower sampling rate during the first monitoring state, the system significantly reduces central processing unit (CPU) usage, wireless communication activity, and battery power consumption during periods when the user is speaking at an appropriate volume. This enables extended battery life (e.g., 8-12 hours or more of continuous operation) while maintaining the responsiveness needed for effective real-time feedback. The transition to the higher sampling rate in the second monitoring state occurs only when potentially problematic voice volume is detected, ensuring that high-resolution monitoring is available precisely when needed.

The system can be configured with user-adjustable thresholds, allowing customization for different users, different environments (e.g., classroom vs. playground), and different communication goals. The first decibel threshold value (TH1) can be set to detect when the user's voice begins to rise above typical conversation levels, while the second decibel threshold value (TH2) can be set to the level at which feedback is desired (e.g., the boundary between acceptable and too-loud speech for a given setting). In some embodiments, threshold values and other configuration parameters are adjustable via a remote device management server, such as a mobile device management (MDM) platform, enabling an administrator to remotely configure multiple wearable devices without physical access. This remote management capability is particularly beneficial in institutional settings such as schools, therapy clinics, or care facilities where multiple devices must be configured and monitored centrally. Both threshold values may be adjusted via a companion application running on a smartphone, tablet, or computer, allowing caregivers, therapists, or the users themselves to customize the system's sensitivity.

The wearable housing may take various forms to accommodate different user preferences and comfort requirements. In some embodiments, the wearable housing comprises a wristband similar to a fitness tracker or watch, worn comfortably on the user's wrist. In other embodiments, the wearable housing comprises a clip-on device that attaches to the user's clothing (e.g., collar, pocket, belt). In still other embodiments, the wearable housing comprises a necklace pendant worn around the user's neck, or a magnetic attachment device that attaches to clothing via magnets. The flexibility in form factor ensures that the device can be worn by individuals with different sensory sensitivities, clothing preferences, or comfort needs. In embodiments utilizing a magnetic attachment device, the wearable housing includes one or more magnets configured to releasably attach the housing to the user's clothing or to a ferromagnetic accessory worn by the user. The magnetic attachment positions the wearable housing against the user's body with sufficient coupling force to transmit haptic feedback vibrations through the user's clothing to the user's skin, while permitting easy removal and repositioning.

In some embodiments, the audio sensor is integrated directly into the wearable housing. In other embodiments, the audio sensor is disposed in a separate audio sensor unit configured to be positioned proximate to the user's mouth (e.g., clipped to a shirt collar or worn as a lapel microphone) and operatively connected to the controller via wireless communication such as Bluetooth Low Energy (BLE). This dual-unit configuration may provide improved voice detection accuracy by positioning the microphone closer to the user's mouth, while keeping the haptic feedback element and battery in a separate, comfortable wearable unit.

The system may employ various techniques to distinguish the user's own voice from background noise and other people's voices. In some embodiments, the audio sensor and controller implement frequency analysis to focus on the frequency range typical of human speech (e.g., 85 Hz to 255 Hz for fundamental frequency, with harmonics up to several kHz). In other embodiments, the system employs temporal pattern analysis to detect the rhythm and cadence characteristic of the user's speech. In still other embodiments, the system uses sensor fusion, combining data from multiple microphones or from an accelerometer or vibration sensor that detects vocal cord vibrations or bone conduction of the user's own voice. These techniques enable the system to provide accurate feedback based on the user's own voice volume rather than reacting to ambient environmental noise.

The invention also provides a method for real-time voice volume self-regulation comprising the steps of: continuously sampling audio data representing voice output of a user; comparing volume levels against threshold values while operating in different monitoring states with different sampling rates; automatically transitioning between states based on volume measurements; activating haptic feedback when appropriate; and implementing a cooldown period to prevent rapid re-triggering. The method operates without storing audio waveform data, protecting user privacy while providing effective assistance.

The system is particularly beneficial for multiple populations. For individuals with autism spectrum disorder or ADHD, the system provides immediate, non-judgmental feedback that helps build self-awareness of voice volume without relying on verbal reminders from others. For individuals who are deaf or hard-of-hearing, the system provides tactile feedback that substitutes for the auditory self-monitoring feedback they lack. For individuals undergoing speech therapy or voice training, the system provides consistent, objective feedback during practice and daily activities. For individuals in occupational settings requiring voice control (e.g., teachers, call center workers), the system provides awareness of voice strain or elevated volume.

The companion application provides additional functionality including threshold configuration, historical data review, progress tracking, and customization of feedback patterns. Users or caregivers can view logs of when and how frequently the system provided feedback, enabling assessment of progress in voice volume self-regulation over time. The application may also enable scheduling different threshold profiles for different times of day or different activities (e.g., quiet threshold during school hours, moderate threshold during after-school activities).

Because the system does not record or store audio waveform data, it addresses privacy concerns that might otherwise limit acceptance of a wearable voice monitoring device. Schools, workplaces, and therapy environments can permit use of the device without concern about unauthorized audio recording. Users can wear the device in all settings without creating privacy issues for others around them.

In some embodiments, the voice volume self-regulating system is implemented as a software application executing on a general-purpose wearable computing device, such as a smartwatch running a mobile operating system. The wearable computing device provides the audio sensor (microphone), haptic feedback element (vibration motor), wireless communications module, memory, and controller (processor) described herein. The software application implements the multi-state monitoring process, including the first monitoring state, second monitoring state, alert state, and cooldown state, by controlling the microphone sampling rate and vibration motor activation through application programming interfaces (APIs) provided by the wearable computing device's operating system. In some such embodiments, the wearable computing device operates in a restricted or kiosk mode managed by a mobile device management (MDM) platform, wherein the device's functionality is limited substantially to executing the voice volume self-regulating software application. This configuration effectively transforms the general-purpose wearable computing device into a dedicated assistive technology device. The MDM platform may enable remote enrollment, configuration, monitoring, and update of multiple wearable devices by an administrator, caregiver, or therapist.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a perspective view of a wearable device, in the form of a watch, according to a first embodiment of the present invention;

FIG. 2 is a plan view of an underside of the wearable device of FIG. 1;

FIG. 3 is a flow diagram illustrating a process for real-time voice volume self-regulation using multi-state monitoring with adaptive sampling rates and haptic feedback via the wearable device in FIG. 1 according to an embodiment of the present invention;

FIG. 3A is an alternative flowchart illustrating the multi-state monitoring process implemented via software APIs on a general-purpose wearable computing device;

FIG. 4 is a plan view of an underside of a wearable device, shown as a clip-on device, according to a second embodiment of the present invention;

FIG. 5 is a plan view of an underside of a wearable device, shown as a pendant, according to a third embodiment of the present invention; and

FIG. 6 is a system architecture diagram showing an alternative embodiment implemented on a commercial smartwatch in restricted-access mode with remote MDM management.

### DETAILED DESCRIPTION

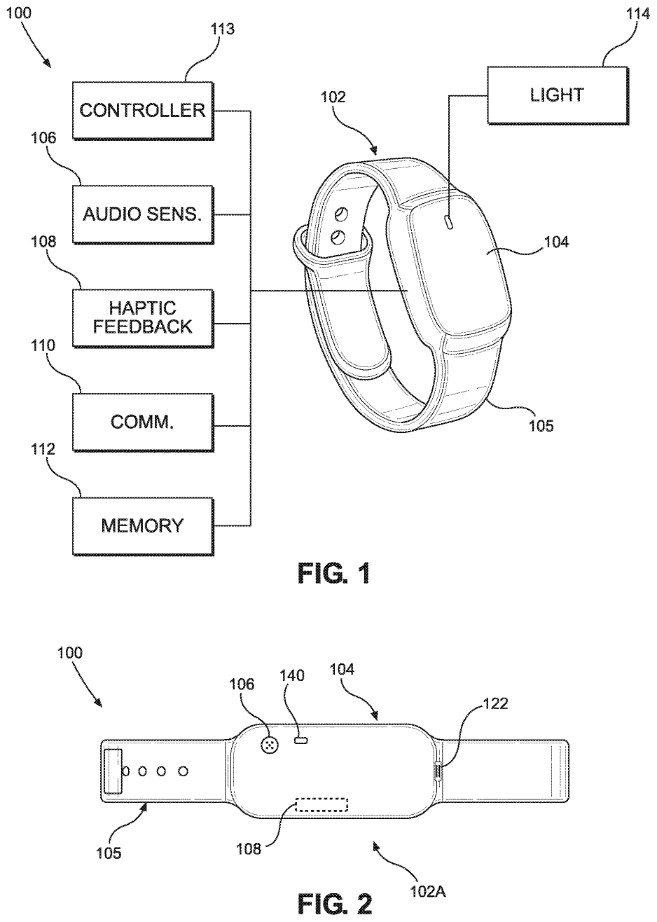

Referring to the drawings, and with particular reference to FIGS. 1 and 2, there is shown a voice volume self-regulating system 100 according to a first embodiment of the present invention. The system 100 includes a wearable device 102 in accordance with the present invention. In particular, a wearable device 102, shown in the form of a watch 102A, is provided with a wearable housing 104 mounted to an adjustable strap 105.

Within the wearable housing 104, the wearable device 102 includes an audio sensor 106, a haptic feedback element 108, a wireless communications module 110, a memory 112 for storing relevant data, and a controller 113 for controlling operations of the wearable device according to one or more stored programs. In addition, the wearable housing 104 is also provided with an externally visible indicator light 114 (e.g., an LED), a battery (not shown), and a charging port 122.

The audio sensor 106 is configured to capture audio data in the immediate vicinity of the user. In preferred embodiments, the audio sensor 106 comprises a microphone or other sound sensor placed in or on the housing 104. The audio sensor 106 is preferably an omnidirectional electret or microelectromechanical systems (MEMS) microphone capable of picking up the user's voice even when the wearable device 102 is located on the user's wrist or elsewhere on the user's body. The sensitivity of the audio sensor 106 is preferably calibrated to the typical speaking volume range of human speech, generally in the range of approximately 40 to 80 decibels (dB) for normal conversation, with the ability to detect elevated volumes up to approximately 100 dB or more.

In operation, the audio sensor 106 continuously monitors sound levels in the user's environment. The controller 113, operatively connected to the audio sensor 106, receives and processes the audio data to extract volume level information. The controller 113 implements signal processing techniques to analyze the incoming audio and determine the current sound pressure level (SPL) or decibel level. In some embodiments, the controller 113 implements filtering algorithms to focus on the frequency range characteristic of human speech (approximately 85 Hz to 8000 Hz), reducing the influence of low-frequency rumble or high-frequency environmental noise.

The haptic feedback element 108 provides tactile feedback to the user. In preferred embodiments, the haptic feedback element 108 comprises a vibration motor or actuator. The vibration motor may be an eccentric rotating mass (ERM) motor, a linear resonant actuator (LRA), or other suitable vibration-producing device. When activated by the controller 113, the haptic feedback element 108 produces a noticeable vibration that the user can feel against their skin. The intensity and pattern of the vibration can be controlled by the controller 113. In some embodiments, the vibration is a continuous vibration that persists as long as the alert condition exists. In other embodiments, the vibration follows a pattern such as pulses or varying intensity levels.

The controller 113 comprises a microcontroller, microprocessor, or other suitable processing unit operatively connected to the audio sensor 106, the haptic feedback element 108, the wireless communications module 110, and the memory 112. The controller 113 executes firmware or software instructions stored in the memory 112 to implement the multi-state monitoring process described herein. The controller 113 includes or is operatively connected to analog-to-digital conversion circuitry for converting the analog audio signal from the audio sensor 106 into digital audio data for processing.

The wireless communications module 110 enables the wearable device 102 to communicate with external devices such as smartphones, tablets, or computers. In preferred embodiments, the wireless communications module 110 implements BLE communication, which provides low power consumption suitable for battery-powered wearable devices. In other embodiments, the wireless communications module 110 implements cellular communication (e.g., LTE or 5G) enabling the wearable device 102 to communicate with remote servers or companion applications without requiring a locally paired smartphone. In still other embodiments, the wireless communications module 110 implements Wi-Fi communication. The wearable device 102 may support multiple wireless communication protocols simultaneously. The wireless communications module 110 enables the wearable device 102 to pair with a companion application running on an external device, allowing configuration of settings, synchronization of data, and firmware updates.

The memory 112 stores firmware or software instructions executed by the controller 113, configuration data such as threshold values and sampling rates, and event log data such as timestamps of threshold exceedances. In some embodiments, the memory 112 comprises non-volatile memory (e.g., flash memory) for storing firmware and configuration data, and volatile memory (e.g., SRAM) for temporary data storage during operation. Importantly, the memory 112 does not store raw audio waveform data captured by the audio sensor 106. Instead, the controller 113 processes the audio data to extract volume level measurements and immediately discards the raw audio data, protecting user privacy.

The indicator light 114 provides visual feedback to the user or others. In some embodiments, the indicator light 114 comprises one or more light-emitting diodes (LEDs) that can display different colors or patterns. The indicator light 114 may be used to indicate various states such as power on, battery status, Bluetooth connection status, or operational mode. In some embodiments, the indicator light 114 is minimally used or can be disabled to maintain discretion and avoid drawing attention to the user.

The battery (not shown) provides electrical power to all components of the wearable device 102. In preferred embodiments, the battery comprises a rechargeable lithium-ion or lithium-polymer battery with sufficient capacity to power the device for at least 8-12 hours of continuous operation, and preferably 24 hours or more. The charging port 122 enables recharging of the battery. In some embodiments, the charging port 122 comprises a USB-C port, micro-USB port, or proprietary connector. In other embodiments, the wearable device 102 implements wireless charging (e.g., Qi wireless charging standard), eliminating the need for a physical charging port.

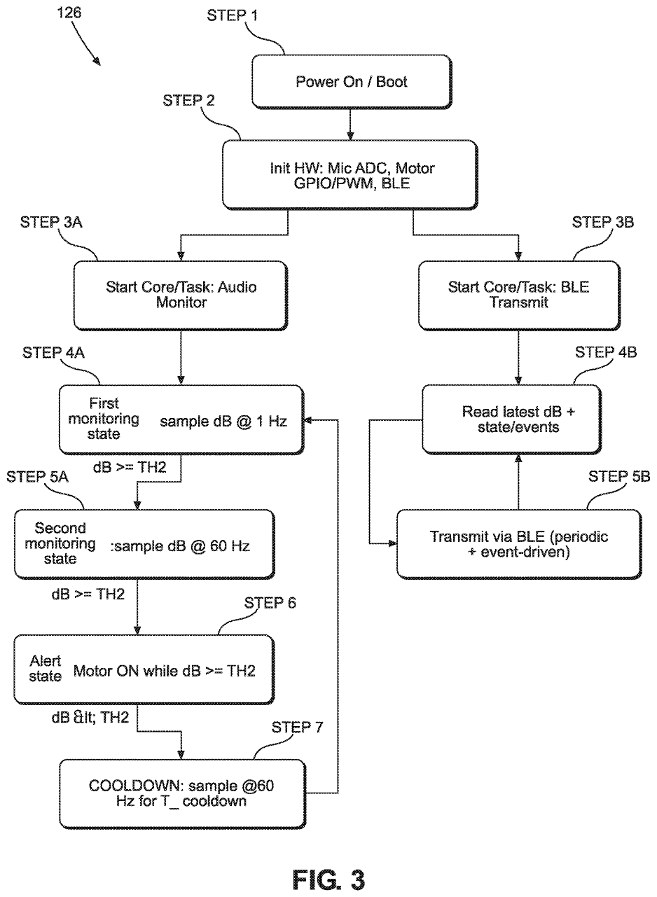

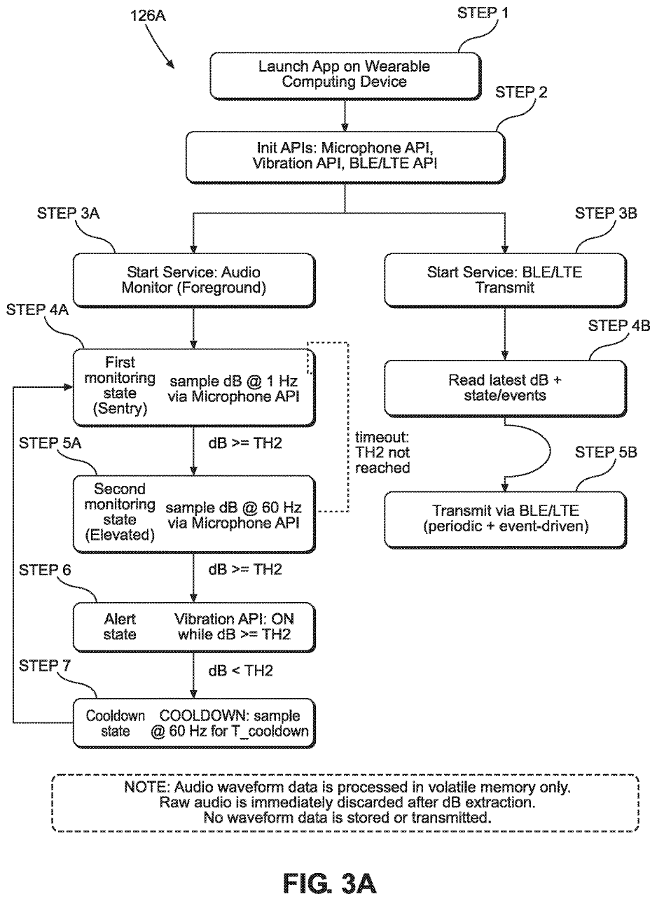

Referring now to FIG. 3, the operation of the wearable device 102 according to the multi-state monitoring process 126 is described. The process 126 implements a state machine architecture with four distinct operational states: a first monitoring state (Sentry), a second monitoring state (Elevated Monitor), an alert state (Vibrating), and a cooldown state (Cooldown). The state machine architecture enables efficient power management while maintaining responsiveness to the user's voice volume.

At STEP 1, the wearable device 102 is powered on. At STEP 2, the controller 113 initializes the audio sensor 106, the haptic feedback element 108, and the wireless communication function. This initialization may occur via the wireless communications module 110. After initialization, the controller 113 initiates two concurrent sets of tasks, starting with audio monitoring (STEP 3A) and wireless communication (STEP 3B).

Following STEP 3A, the controller 113 enters the first monitoring state (STEP 4A), also referred to as the Sentry state. In the Sentry state, the controller 113 samples audio data from the audio sensor 106 at a first sampling rate. In a preferred embodiment, the first sampling rate is approximately 1 Hz (one sample per second), though other low sampling rates such as 0.5 Hz to 2 Hz may be used depending on the application. At this sampling rate, the controller 113 measures the volume level of the audio data and compares it against a first decibel threshold value (TH1).

The first decibel threshold value (TH1) is set to detect when the user's voice begins to rise above typical conversation levels. In a preferred embodiment, TH1 is set in the range of approximately 60-70 dB, though this value may be adjusted based on the user's typical speaking volume, the acoustic environment, and the desired sensitivity. Preferably, the first monitoring state functions as a low-power mode, continuously watching for potentially elevated voice volume without consuming excessive processing power or battery energy.

When the measured volume level meets or exceeds TH1, the controller 113 automatically transitions from the first monitoring state to the second monitoring state (STEP 5A), also referred to as the Elevated Monitor state. This transition occurs immediately and automatically upon detected sound levels exceeding the TH1 threshold, thereby ensuring rapid response to changes in the user's voice volume.

In the second monitoring state (STEP 5A), the controller 113 increases the sampling rate to a second sampling rate significantly greater than the first sampling rate. In a preferred embodiment, the second sampling rate is approximately 60 Hz (sixty samples per second), though other rates such as 30 Hz to 100 Hz may be used depending on the desired responsiveness and available processing power. This higher sampling rate provides much finer temporal resolution, enabling the controller 113 to accurately track rapid changes in voice volume and determine precisely when feedback should be provided to the user.

While in the second monitoring state, the controller 113 compares the measured volume level against a second decibel threshold value (TH2). The second decibel threshold value is greater than the first decibel threshold value and represents the boundary between acceptable voice volume and too-loud voice volume for the given setting. In a preferred embodiment, TH2 is set in the range of approximately 75-85 dB, though this value may be adjusted based on user preferences and environmental requirements. The separation between TH1 and TH2 (e.g., 10-15 dB) provides a buffer zone that prevents false triggers while ensuring that genuinely elevated voice volume is detected.

If the volume level reaches or exceeds TH2 while in the second monitoring state, the controller 113 immediately and automatically transitions to the alert state (STEP 6), also referred to as the Vibrating state. In the Vibrating state, the controller 113 activates the haptic feedback element 108, causing it to vibrate. The vibration provides immediate tactile feedback to the user, alerting them that their voice volume is above the desired level. The vibration continues as long as the measured volume level remains at or above TH2, providing continuous feedback to encourage the user to lower their voice.

When the volume level drops below TH2 (indicating that the user has successfully lowered their voice), the controller 113 deactivates the haptic feedback element 108 and transitions from the alert state to the Cooldown state (STEP 7). The Cooldown state prevents immediate re-entry into the alert state, avoiding rapid re-triggering and “vibration flicker” that could be confusing or annoying to the user.

During the Cooldown state, the controller 113 continues to sample audio data at the second sampling rate (e.g., 60 Hz) and monitor the volume level. However, even if the volume level temporarily exceeds TH2 during the Cooldown period, the controller 113 does not activate the haptic feedback element 108 or re-enter the alert state. Instead, the controller 113 waits for a predetermined cooldown duration to expire. In a preferred embodiment, the cooldown duration is approximately 3 seconds, though other durations such as 1-5+ seconds may be used depending on the desired user experience.

After the cooldown duration expires, the controller 113 transitions from the Cooldown state back to the first monitoring state (Sentry state, STEP 4A), returning to the low-power monitoring mode. This completes one cycle of the state machine. The controller 113 continues cycling through these states as long as the wearable device 102 remains powered on.

If, while in the second monitoring state (STEP 5A), the volume level does not reach TH2 within a predetermined monitoring duration (e.g., 2-5 seconds), the controller 113 automatically transitions back to the first monitoring state (STEP 4A) without entering the alert state. This prevents the system from remaining in the higher-power Elevated Monitoring state when the user's voice was only briefly elevated (exceeding TH1) but did not reach the level requiring feedback (TH2). This feature further optimizes power consumption.

Concurrently with the audio monitoring process, the controller 113 implements wireless communication functionality. At STEP 4B, the controller 113 reads the latest decibel value measured by the audio sensor 106 and the current operational state (e.g., Sentry, Elevated Monitor, Vibrating, or Cooldown). At STEP 5B, the controller 113 preferably transmits this data via the wireless communications module 110 to a paired external device such as a smartphone running a companion application.

The data transmitted via wireless communication comprises metadata only, which metadata may include the current decibel measurement, the current state, and timestamp information. Critically, in preferred embodiments, the raw audio waveform data captured by the audio sensor 106 is never transmitted. This architecture ensures user privacy by preventing any possibility of audio recording, playback, or analysis of the content of the user's speech. Preferably, only volume level information (e.g., decibels) and timing information are transmitted and stored.

The companion application receives the transmitted data and may display it to the user or caregiver in real time, log it for later review, or use it to generate reports showing the user's progress in voice volume self-regulation over time. The companion application also enables configuration of the threshold values (TH1 and TH2), sampling rates, cooldown duration, and other parameters, transmitting configuration changes back to the wearable device 102 via the wireless connection.

In preferred embodiments, the system is configured to monitor the user's own voice output rather than ambient environmental sound levels. This is beneficial for providing feedback about the user's own vocalization volume rather than reacting to environmental noise conditions. In some embodiments, the system implements techniques to distinguish the user's own voice from background noise and other people's voices, improving the accuracy of voice volume detection. One technique involves frequency analysis. The controller 113 may implement a bandpass filter or frequency analysis algorithm that focuses on the frequency range typical of human speech, particularly the fundamental frequency range (approximately 85 Hz to 255 Hz for adults) and the lower harmonic frequencies (up to approximately 4000 Hz). Environmental noise such as traffic, air conditioning, or machinery often has a different frequency profile and can be attenuated by this filtering.

Another technique involves temporal pattern analysis. Human speech exhibits characteristic temporal patterns including alternating voiced and unvoiced segments, rhythmic cadence, and typical syllable durations. The controller 113 may implement algorithms that analyze these temporal patterns to distinguish speech (particularly the user's own speech) from continuous background noise or transient non-speech sounds.

In some embodiments, the system implements sensor fusion, combining data from multiple sensors to improve voice detection accuracy. For example, the wearable housing 104 may include an accelerometer or vibration sensor in addition to the audio sensor 106. When the user speaks, their vocal cords produce vibrations that propagate through the user's body and can be detected by the accelerometer or vibration sensor. By combining the audio signal from the audio sensor 106 with the vibration signal from the accelerometer, the controller 113 can more reliably distinguish the user's own voice from environmental sounds or other people's voices.

In embodiments where the audio sensor is integrated into a wrist-worn device, bone conduction of the user's voice through the arm provides an additional signal that can be detected. The characteristic time delay and frequency response of bone-conducted sound can be used to confirm that detected audio originates from the user's own voice. These techniques enable the system to provide accurate feedback based specifically on the user's own voice volume, rather than reacting inappropriately to loud environmental noise or nearby conversations.

As described above, the controller 113 processes audio data to extract volume level measurements but preferably does not store raw audio waveform data in the memory 112. In preferred embodiments, the audio sensor 106 continuously captures audio, the controller 113 performs real-time digital signal processing to calculate the current decibel level, and the raw audio buffer is immediately overwritten with the next audio sample. At no point is complete audio waveform data written to non-volatile memory or transmitted via wireless communication.

This preferred architecture ensures that the system cannot be used to record conversations, and that even if the wearable device 102 were lost, stolen, or forensically examined, no audio content could be recovered. In such cases, only metadata such as decibel measurements, timestamps, and state information is stored. This design addresses privacy concerns that might otherwise prevent acceptance of a wearable voice monitoring device in schools, workplaces, healthcare settings, and other environments where audio recording would be prohibited or socially unacceptable.

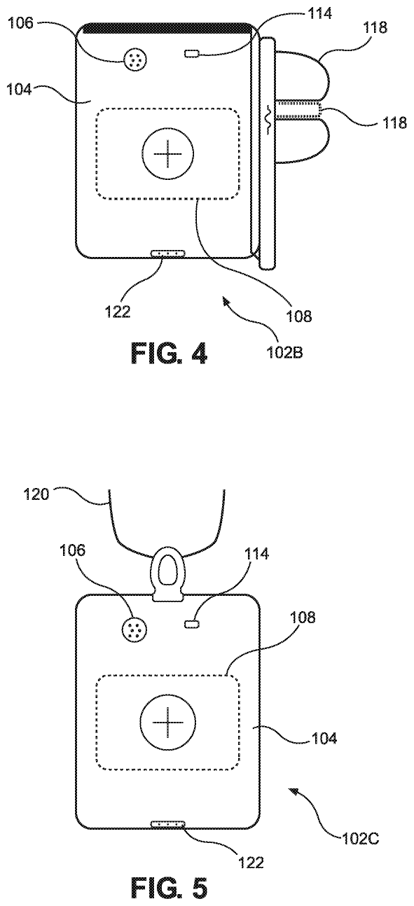

While the wearable device 102 described above is shown as a watch 102A, other types of wearable devices may be used instead. For example, the wearable device 102 may take the form of a bracelet, necklace, headband, or other wearable accessory. FIGS. 4 and 5 illustrate alternative embodiments demonstrating the flexibility of the system to accommodate different user preferences and needs.

### Alternative Hardware Implementation—Commercial Smartwatch Platform

In some embodiments, the wearable device 102 comprises a commercially available smartwatch or general-purpose wearable computing device configured to execute software implementing the multi-state monitoring process described herein. Examples of suitable commercial smartwatch platforms include, without limitation, Samsung Galaxy® Watch series, Apple Watch®, Wear OS™ devices, and other consumer smartwatches having an audio sensor, haptic feedback capability, wireless communication, and sufficient processing power.

When implemented on a commercial smartwatch platform, the device may be configured to operate in a restricted-access mode, kiosk mode, or single-application mode to ensure that the voice monitoring functionality operates continuously without user interference. For example, in enterprise deployments using Samsung® Knox Manage® or similar mobile device management (MDM) platforms, the smartwatch can be remotely configured to operate exclusively in voice volume monitoring mode, with access to other applications and settings restricted by the MDM administrator.

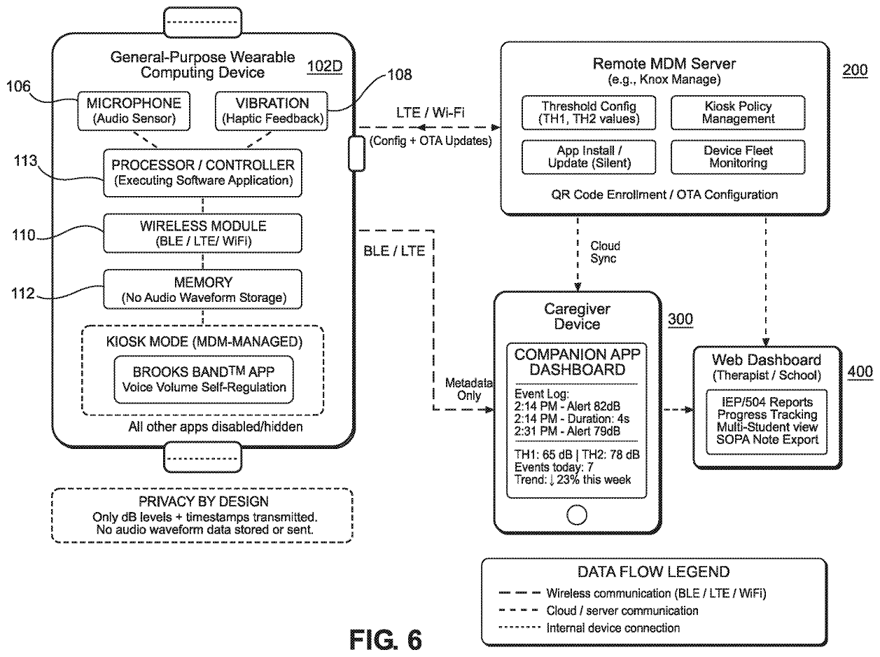

Referring now to FIG. 6, a system architecture for the commercial smartwatch embodiment is shown. The system includes a smartwatch 102D operating in restricted-access mode, a remote MDM server 200 for device configuration and policy enforcement, a caregiver companion application 202 running on a smartphone or tablet, and optionally a web-based dashboard 204 for data review and reporting. The smartwatch 102D communicates with the caregiver companion application 202 via Bluetooth Low Energy or Wi-Fi, and may communicate directly with the MDM server 200 via cellular LTE/5G connection when the smartwatch includes cellular capability.

In this embodiment, the controller 114 comprises the smartwatch's existing processor (e.g., Exynos, Snapdragon Wear, or Apple S-series processor) executing software implementing the multi-state monitoring process. The software interacts with the smartwatch's operating system (e.g., Wear OS, watchOS, Tizen) via published APIs to access the audio sensor, activate haptic feedback, and manage wireless communication. Configuration parameters such as threshold values (TH1 and TH2), sampling rates, and cooldown duration may be set remotely by a caregiver or administrator via the MDM server 200 or companion application 202, and transmitted to the smartwatch 102D for implementation.

The commercial smartwatch embodiment provides several advantages including leveraging existing hardware infrastructure, enabling large-scale enterprise or institutional deployments without custom hardware manufacturing, and allowing users to utilize a familiar consumer device form factor. The MDM-managed kiosk mode ensures that the device functions reliably as a voice monitoring system while preventing users from disabling the monitoring functionality or installing unrelated applications.

### Other Embodiments & Features

The following describes additional embodiments, variations, and optional features of the invention that may be implemented individually or in combination with the embodiments described above.

Referring to FIG. 4, another embodiment of the wearable device 102B is shown in a clip-on configuration. The wearable device 102B includes the same functional components as described above (i.e., audio sensor 106, haptic feedback element 108, controller 113, wireless communications module 110, memory 112, and indicator light 114) housed within a wearable housing 104. The wearable housing 104 of device 102B is provided with prong clips 118 or other attachment mechanisms that enable the device to be clipped to the user's clothing, such as a shirt collar, pocket edge, or belt.

The clip-on configuration provides several advantages for certain users. It may be more comfortable for users who do not tolerate wrist-worn devices due to sensory sensitivities. It positions the audio sensor 106 closer to the user's mouth (when clipped to a collar), potentially improving voice detection accuracy. It is less visible than a wristband, which may be preferred by users who wish to use the device discreetly. The clip-on configuration is particularly suitable for professional or formal settings where a wristband might be considered inappropriate.

Referring to FIG. 5, a third embodiment of the wearable device 102C is shown in a pendant or necklace configuration. The wearable device 102C includes the same functional components housed within a wearable housing 104 configured as a pendant. The pendant may be suspended from a support 120, such as a chain, cord, or lanyard that the user wears around their neck. The pendant configuration positions the audio sensor 106 near the user's chest and throat, providing good proximity to the user's voice while remaining comfortable and unobtrusive.

The pendant configuration may be aesthetically appealing to users who prefer jewelry-style accessories. It is suitable for users of all ages, including young children who might play roughly with a wristband device. The pendant hangs freely and does not require adjustment like a wristband strap. In some embodiments, the pendant housing 104 is designed to be visually attractive and may incorporate decorative elements, making it appear as ordinary jewelry rather than assistive technology.

In some embodiments, the audio sensor 106 is not integrated into the wearable housing 104 but is instead disposed in a separate audio sensor unit. The separate audio sensor unit is configured to be positioned proximate to the user's mouth, such as clipped to a shirt collar, worn as a lapel microphone, or attached magnetically to clothing near the throat. The audio sensor unit is operatively connected to the controller 113 (which may be located in a wristband, clip-on, or other wearable housing) via wireless communication such as Bluetooth Low Energy.

This dual-unit configuration combines the advantages of close microphone placement (improved voice detection accuracy, better discrimination from environmental noise) with the advantages of comfortable haptic feedback placement (wristband providing vibration against the wrist, which is a sensitive and noticeable location). The audio sensor unit and the main wearable unit communicate bidirectionally, with the audio sensor unit transmitting volume level measurements to the main unit and the main unit transmitting control commands to the audio sensor unit (e.g., to adjust microphone gain or enter a low-power sleep mode).

The system is particularly beneficial for multiple populations with different needs. For individuals with autism spectrum disorder or ADHD, the system provides immediate, consistent, non-judgmental feedback that helps build self-awareness of voice volume. The haptic feedback is private and does not draw attention from peers, avoiding social embarrassment. Over time, users internalize the feedback and develop improved ability to modulate their voice independently.

For individuals who are deaf or hard-of-hearing, the system substitutes tactile feedback for the auditory self-monitoring feedback they lack. This enables them to regulate their speaking volume in real time without relying on visual cues or input from others. The system is particularly valuable in situations where the user cannot easily see others' reactions or where social feedback about volume would be delayed or uncomfortable.

For individuals undergoing speech therapy, voice training, or vocal rehabilitation, the system provides consistent, objective feedback during practice sessions and daily activities. Speech-language pathologists can configure the threshold values to match therapeutic goals and can review logged data to track progress over time. The system extends the benefits of therapy beyond formal therapy sessions, providing continuous support throughout the user's day.

For individuals in occupational settings requiring voice control, such as teachers, call center workers, singers, or public speakers, the system provides awareness of voice strain or elevated volume that might lead to vocal fatigue or damage. By alerting the user when their voice volume is consistently high, the system encourages vocal rest and prevents overuse injuries.

### Voice Discrimination

In some embodiments, the controller 114 implements voice discrimination algorithms to distinguish the user's own voice from ambient environmental sounds and other persons' voices. This may be accomplished through frequency analysis of the fundamental frequency (F0) range characteristic of the user's voice, temporal pattern recognition of the user's speech cadence, or sensor fusion combining audio data with accelerometer or vibration sensor data detecting bone-conducted vibrations from the user's vocal cords. By discriminating the user's voice from background noise, the system provides haptic feedback specifically in response to the user's own speaking volume rather than environmental noise levels.

### Adaptive Threshold Adjustment

In some embodiments, the first decibel threshold value (TH1) and the second decibel threshold value (TH2) are automatically adjusted based on ambient noise levels in the user's environment. The controller 114 may periodically sample ambient noise during periods when the user is not speaking (detected via absence of voice-characteristic frequency patterns or vibration sensor data) and adjust the threshold values upward in noisy environments or downward in quiet environments to maintain appropriate sensitivity.

### Configurable Sampling Rate Differential

In preferred embodiments, the second sampling rate is at least one order of magnitude greater than the first sampling rate (e.g., 60 Hz vs. 1 Hz, representing a 60× differential). In some embodiments, the differential may be configured to be 10×, 30×, 50×, 100× or other values depending on desired responsiveness, power consumption constraints, and processing capabilities of the controller 114.

### Magnetic Attachment Mechanism

In some embodiments, particularly clip-on configurations, the wearable housing 104 includes magnetic attachment elements enabling the device to be magnetically attached to clothing, fabric, or metallic surfaces. The magnetic attachment mechanism provides secure positioning while enabling easy removal and repositioning, and may be particularly suitable for users who have difficulty manipulating mechanical clips or clasps.

### Cellular Connectivity

In some embodiments where the wearable device 102 comprises a smartwatch or other device with integrated cellular capability (e.g., LTE, 5G), the wireless communications module 110 may communicate directly with remote servers, cloud-based services, or MDM platforms via cellular data connection without requiring pairing to an intermediate smartphone or tablet. This configuration enables standalone operation and remote management in enterprise or institutional deployments.

### User Profile Selection

In some embodiments, the system implements multiple user profiles or operational modes selectable by the user, caregiver, or administrator. For example, a “classroom mode” may implement lower threshold values and shorter cooldown durations for use in quiet indoor settings, while a “playground mode” may implement higher threshold values appropriate for outdoor recreational settings. Profile selection may be performed manually via the companion application 202 or automatically based on location (via GPS), time of day, or detected ambient noise levels.

### Web-Based Dashboard

In some embodiments, the system includes a web-based dashboard 204 accessible via internet browser, providing caregivers, therapists, educators, or administrators with access to aggregated usage data, progress reports, and device configuration controls. The web dashboard 204 may display visualizations of volume exceedance events over time, trends in self-regulation performance, and comparative data across multiple users (in institutional deployments) while maintaining user privacy through anonymization and aggregate reporting.

### Privacy Architecture

As described throughout this specification, the system implements a privacy-preserving architecture in which audio waveform data captured by the audio sensor 106 is processed in real-time to extract volume level measurements but is not stored in non-volatile memory and is not transmitted via the wireless communications module 110. Only metadata including decibel measurements, timestamps, and operational state information is stored and transmitted. This architecture ensures that the system cannot be used to record, playback, or analyze the content of users' speech, addressing privacy concerns in educational, healthcare, workplace, and other sensitive environments.

What is claimed is:

1. A voice volume self-regulating system comprising:
an audio sensor configured to capture audio data;
a wearable housing configured to be worn on a user's body;
at least one haptic feedback element disposed in or on the wearable housing; and
a controller operatively connected to the audio sensor and the at least one haptic feedback element, the controller configured to:
operate in a first monitoring state wherein the controller samples the audio data from the audio sensor at a first sampling rate and compares a volume level of the audio data against a first decibel threshold value;
automatically transition to a second monitoring state when the volume level meets or exceeds the first decibel threshold value, wherein in the second monitoring state the controller samples the audio data at a second sampling rate greater than the first sampling rate and compares the volume level of the audio data against a second decibel threshold value greater than the first decibel threshold value;
automatically transition to an alert state when the volume level meets or exceeds the second decibel threshold value while in the second monitoring state, and activate the at least one haptic feedback element to provide tactile feedback to the user;
automatically transition to a cooldown state after the alert state terminates, wherein the cooldown state prevents re-entry into the alert state for a predetermined cooldown duration; and
continuously monitor voice volume of the user without storing audio waveform data;
transition between the first monitoring state, the second monitoring state, the alert state, and the cooldown state based solely on decibel measurements; and
process audio data to extract only volume level information and immediately discarding raw audio waveform data without storing or externally transmitting the raw audio waveform data.

2. The system of claim 1, wherein the controller is further configured to automatically transition from the second monitoring state back to the first monitoring state when a predetermined monitoring duration expires without the volume level reaching the second decibel threshold value.

3. The system of claim 1, wherein the first monitoring state comprises a low-power monitoring mode that reduces at least one of: central processing unit utilization, wireless communication activity, and battery power consumption, relative to the second monitoring state.

4. The system of claim 1, wherein the first decibel threshold value and the second decibel threshold value are user-configurable.

5. The system of claim 1, wherein the wearable housing comprises one of: a wristband, a clip-on device, a necklace pendant, and a magnetic attachment device.

6. The system of claim 1, wherein the audio sensor is integrated into the wearable housing.

7. The system of claim 1, wherein the audio sensor is disposed in a separate audio sensor unit configured to be positioned proximate to the user's mouth and operatively connected to the controller via wireless communication.

8. The system of claim 7, wherein the wireless communication comprises Bluetooth communication.

9. The system of claim 1, wherein the at least one haptic feedback element comprises at least one vibration motor.

10. The system of claim 1, wherein the controller is configured to process the audio data locally without transmitting audio waveform data to an external device.

11. The system of claim 1, wherein during the cooldown state the controller prevents transition to the alert state even when the volume level meets or exceeds the second decibel threshold value.

12. The system of claim 1, wherein the wearable device comprises a commercially available smartwatch operating in a restricted-access mode.

13. The system of claim 12, wherein configuration parameters including the first decibel threshold value and the second decibel threshold value are remotely configurable via a mobile device management server.

14. A method for real-time voice volume self-regulation, the method comprising:
continuously sampling, by an audio sensor of a wearable device worn by a user, audio data representing voice output of the user;
comparing, by a controller of the wearable device, a volume level of the audio data against a first decibel threshold value while operating in a first monitoring state at a first sampling rate;
automatically transitioning to a second monitoring state when the volume level meets or exceeds the first decibel threshold value;
sampling the audio data at a second sampling rate greater than the first sampling rate while in the second monitoring state;
comparing the volume level of the audio data against a second decibel threshold value greater than the first decibel threshold value while in the second monitoring state;
automatically transitioning to an alert state and activating at least one haptic feedback element of the wearable device when the volume level meets or exceeds the second decibel threshold value, thereby providing tactile notification to the user;
automatically transitioning to a cooldown state after the alert state terminates, wherein the cooldown state prevents re-entry into the alert state for a predetermined cooldown duration; and
wherein the method operates without storing audio waveform data and transitions between states based solely on decibel measurements of the user's voice output.

15. The method of claim 14, further comprising automatically transitioning from the second monitoring state back to the first monitoring state when a predetermined monitoring duration expires without the volume level reaching the second decibel threshold value.

16. The method of claim 14, wherein the first monitoring state comprises a low-power monitoring mode that reduces at least one of: central processing unit utilization, wireless communication activity, and battery power consumption, relative to the second monitoring state.

17. The method of claim 14, wherein the first decibel threshold value and the second decibel threshold value are user-configurable.

18. The method of claim 14, wherein the wearable device comprises one of: a wristband, a clip-on device, a necklace pendant, and a magnetic attachment device.

19. The method of claim 14, wherein the audio sensor is integrated into a housing of the wearable device.

20. The method of claim 14, wherein the audio sensor is disposed in a separate audio sensor unit positioned proximate to the user's mouth and operatively connected to the controller via Bluetooth communication.

21. The method of claim 14, wherein the at least one haptic feedback element comprises at least one vibration motor.

22. The method of claim 14, wherein during the cooldown state the controller prevents transition to the alert state even when the volume level meets or exceeds the second decibel threshold value.

23. A non-transitory computer-readable medium storing instructions that, when executed by a processor of a wearable device, cause the wearable device to:
sample audio data from an audio sensor at a first sampling rate;
determine whether a volume level of the audio data meets or exceeds a first decibel threshold value;
responsive to determining that the volume level meets or exceeds the first decibel threshold value, increase sampling to a second sampling rate greater than the first sampling rate;
while sampling at the second sampling rate, determine whether the volume level meets or exceeds a second decibel threshold value greater than the first decibel threshold value;
responsive to determining that the volume level meets or exceeds the second decibel threshold value, activate a haptic feedback element; and
process the audio data without storing audio waveform data in non-volatile memory.
